(19) United States
(12) Patent Application Publication
(10) Pub. No.: US 2012/0121038 A1
(43) Pub. Date: May 17, 2012

(54) Processing Method And Device For Simulating And Adding Noise To Digital Signals

(75) Inventors: Zhicheng Liu, Nanjing City (CN); Qinyong Yang, Nanjing City (CN); Jin'e Xie, Nanjing City (CN); Xinbiao Duan, Nanjing City (CN); Wuliang Sun, Nanjing City (CN)

(73) Assignees: Sinopec Geophysical Research Institute, Nanjing City (CN); China Petroleum & Chemical Corporation, Beijing (CN)

(21) Appl. No.: 13/274,262

(22) Filed: Oct. 14, 2011

(30) Foreign Application Priority Data
Oct. 15, 2010 (CN) 201010507993.3

(51) Int. Cl. H04L 25/49

(52) U.S. Cl. 375/296

(57) ABSTRACT

The invention relates to a method of synthesizing the color-changing noise, which comprises the following steps: collecting target digital signals or target digital signal traces to be subject to the noise-adding processing; generating white noise signals or white noise signal traces; performing a convolution operation on the target digital signals and the white noise signals to generate color-changing noise signals or performing a convolution operation on the target digital signal traces and the white noise signal traces to generate color-changing noise signal traces. In addition, the invention also relates to a method and device for performing simulating and noise-adding processing using the color-changing noise.

### TECHNICAL FIELD

The invention relates to the technical field of digital signal processing, in particular to a processing method and device for simulating and adding noise to digital signals in the field of digital signals processing such as the filed of electronic information, communication (especially wireless communication), biomedicine sciences, image enhancement, radar and geophysical signal processing (especially for the seismic data processing).

### BACKGROUND OF THE INVENTION

In the digital signals processing area, such as the field of geophysical signal processing (especially the seismic data processing), electronic information, biomedicine sciences, radar, communication and image processing and so on, adding noise to the digital signals is generally required for the signal simulating processing. For example, during seismic data processing, it is usually necessary to suppress noise to increase signal-to-noise ratio. Especially for regular noise, such as multiple wave, scattered wave and surface wave etc., it usually has to be eliminated or suppressed by adopting a multi-dimensional filtering method. However, multi-dimensional filtering method may produce aliasing effect, and one of the results caused by the effect is that the output time section is too inflexible. So it is highly necessary to perform simulating and noise-adding processing on the trace gathers after multi-dimensional filtering.

The existing digital signal noise-adding methods can be divided into two types, one is to add white noise to digital signals, and the other is to add colored noise to digital signals.

The white noise refers to the random noise signal whose power density is a constant in an unlimited frequency range, and the properties of one sample is uncorrelated with any other one, which represents the stochasticity of signals to some degree. The colored noise refers to the random noise signal whose power density varies with the signal frequencies, and it may be identified according to the sensitivity to different frequency ranges. The common colored noise includes pink noise, red noise, orange noise, blue noise, purple noise, grey noise, brown noise and black noise (static noise). Currently, studies on noise in the field of digital signal processing are still in the stage of identifying noise, while the study on the synthesis of new noise is almost blank.

As mentioned previously, the noise-adding processing in the prior art is usually adding white noise or colored noise to the target signals or signal traces. Specifically, in the prior art, Sᵢ′;(t) is the noise-added signal trace obtained by directly adding a white noise signal traces to the target signal traces, which is one of the conventional noise-adding methods (FIG. 3 and FIG. 8 respectively shows the time section and the spectrum of the noise-added signal trace gather). It has a general expression of Sᵢ′(t)=Sᵢ(t)+μNᵢ(t), wherein Sᵢ(t) is the target signal trace which is to be subject to the noise-adding and simulating processing (FIG. 1 and FIG. 6 show the time section and the spectrum of the target signal trace gather, respectively), Nᵢ(t) is the white noise signal trace (FIG. 2 and FIG. 7 respectively shows the time section and the spectrum of the white noise signal trace gather), μ represents the proportionality coefficient, t represents the time and i represents the sequence number of signal traces.

It can be seen from FIG. 3 and FIG. 8 that the noise-adding method of directly adding white noise to the target signal or signal trace cannot truly reflect or restore the original waveform system, so it has a low simulation degree. Likewise, the noise-adding method of directly adding colored noise to the target signal cannot truly reflect or restore the original waveform system, so it also has a low simulation degree.

### SUMMARY OF THE INVENTION

In order to address one or more of the above-mentioned problems present in the prior art, the invention provides a new noise generating method for performing simulating and noise-adding processing in the field of digital signal processing, which generates a new synthetic noise. This new synthetic noise is a natural and realistic random noise, and the signal or signal trace that is subject to a noise-adding by the new noise has an extremely high simulation degree.

The invention provides a method of generating color-changing noise, which comprises the following steps:

Step 1: collecting target digital signals or target digital signal traces;

Step 2: generating white noise signals or white noise signal traces;

Step 3: performing a convolution operation on the target digital signals and the white noise signals to generate color-changing noise signals, or performing a convolution operation on the target digital signal traces and the white noise signal traces to generate color-changing noise signal traces.

The color-changing noise signals or signal traces are digital signals or signal traces obtained by performing a convolution operation on the target digital signals or signal traces and the white noise signals or signal traces.

Preferably, the color-changing noise signal is represented by N̂(t), which is expressed as

N̂(t)=N(t)*S(t)

wherein, N(t) represents the white noise signal, S(t) represents the target signal that is to be subject to the noise-adding processing, t represents the time, and the operator ‘*’ represents the convolution operation.

Preferably, the color-changing noise signal trace is represented by Nᵢ̂(t), which is expressed as

Nᵢ̂(t)=Nᵢ(t)*Sᵢ(t)

wherein, Nᵢ(t) represents the white noise signal trace, Sᵢ(t) represents the target signal trace that is to be subject to the noise-adding processing, i represents the sequence number of the signal traces, t represents the time, and the operator ‘*’ represents the convolution operation.

According to another aspect of the invention, a method for performing simulating and noise-adding on digital signals is provided, which comprises the following steps:

Step 1: collecting the target digital signals or target digital signal traces to be subject to the noise-adding processing;

Step 2: generating the white noise signals or white noise signal traces;

Step 3: performing a convolution operation on the target digital signals and the white noise signals to generate color-changing noise signals, or performing a convolution operation on the target digital signal traces and the white noise signal traces to generate color-changing noise signal traces;

Step 4: adding the generated color-changing noise signals to the target digital signals, or adding the generated color-changing noise signal traces to the target digital signal traces.

According to yet another aspect of the invention, a device for simulating and adding noise to digital signals is provided, which comprises:

An input means for inputting the target digital signals or target digital signal traces to be subject to the noise-adding processing;

A white noise generating means for generating white noise signals or white noise signal traces;

A color-changing noise generating means configured to perform a convolution operation on the target digital signals and the white noise signals to generate color-changing noise signals, or to perform a convolution operation on the target digital signal traces and the white noise signal traces to generate color-changing noise signal traces;

A noise-adding processing means configured to add the generated color-changing noise signals to the target digital signals, or to add the generated color-changing noise signal traces to the target digital signal traces.

The invention can be widely applied to the technical field of digital signal processing, such as the filed of electronic information, communication (especially wireless communication), biomedicine sciences, image enhancement, radar and geophysical signal processing (especially the seismic data processing), to perform an ideal noise-adding processing. For example, when the invention is applied to process the seismic signals, the target digital signal traces would be the signal traces obtained after a multi-dimensional filtering of the seismic digital signals. By means of the invention, an ideal simulating and noise-adding processing can be performed on the multi-dimensionally filtered digital seismic signals.

Comparing the spectrum output of the signals or signal traces having the color-changing noise added with the spectrum output of the signals or signal traces having white noise or colored noise added, it can be seen that the signals, signal traces or signal trace gather that have been subject to a noise-adding using the color-changing noise of the invention have extremely high simulation degree, so the color-changing noise of the invention is a natural and realistic synthetic random noise.

### BRIEF DESCRIPTION OF THE DRAWINGS

In order to describe the exemplary embodiments of the present invention in further detail, reference will now be made to the appended figures, so that the aspects, features and advantages of the present invention will be understood more thoroughly. In the figures:

FIG. 1 is a graph illustrating the time section of the target signal trace gather to be subject to the noise-adding and simulating processing;

FIG. 2 is a graph illustrating the time section of the white noise signal trace gather;

FIG. 3 is a graph illustrating the time section of the noise-added signal trace gather obtained by directly adding white noise signal traces to the target signal traces according to prior art;

FIG. 4 is a graph illustrating the time section of the signal trace gather of the new random noise (i.e. color-changing noise) generated according to the invention;

FIG. 5 is a graph illustrating the time section of the noise-added signal trace gather obtained by adding the color-changing noise signal traces generated according to the invention to the target signal traces;

FIG. 6 is a graph illustrating the spectrum of the target signal trace gather to be subject to the noise-adding processing;

FIG. 7 is a graph illustrating the spectrum of the white noise signal trace gather;

FIG. 8 is a graph illustrating the spectrum of the noise-added signal trace gather obtained by directly adding the white noise signal traces to the target signal traces according to the prior art;

FIG. 9 is a graph illustrating the spectrum of the color-changing noise signal trace gather generated according to the invention;

FIG. 10 is a graph illustrating the spectrum of the noise-added signal trace gather obtained by adding the color-changing noise traces generated according to the invention to the target signal traces;

FIG. 11 is a graph illustrating the velocity spectrum (see the left part of the graph) and the time section (see the right part of the graph) of a group of original CMP gathers (i.e. Common Midpoint gathers) collected at a seismic prospecting working area according to a preferred embodiment of the invention;

FIG. 12 is a graph illustrating the spectrum of the original CMP gathers as shown in FIG. 11;

FIG. 13 is a graph illustrating the velocity spectrum (see the left part of the graph) and the time section (see the right part of the graph) of the CMP gathers obtained by eliminating the multi-wave interference to the original CMP gathers as shown in FIG. 11 and 12;

FIG. 14 is a graph illustrating the spectrum of the CMP gathers obtained by denoising the CMP gathers having the multi-wave interference eliminated as shown in FIG. 13.

FIG. 15 is a graph illustrating the velocity spectrum (see the left part of the graph) and the time section (see the right part of the graph) of the CMP gathers obtained by adding white noise to the signal gathers as shown in FIG. 13;

FIG. 16 is a graph illustrating the spectrum of the CMP gathers obtained by adding white noise to the signal trace gather as shown in FIG. 13;

FIG. 17 is a graph illustrating the spectrum of the band-pass filtered CMP gathers obtained by band-pass filtering the CMP gathers having white noise added thereto as shown in FIG. 15 and FIG. 16;

FIG. 18 is a graph illustrating the velocity spectrum (see the left part of the graph) and the time section (see the right part of the graph) of the CMP gathers obtained by adding 30% of the original noise (i.e. colored noise) to the signal trace gather shown in FIG. 13 according to the prior art;

FIG. 19 is a graph illustrating the velocity spectrum (see the left part of the graph) and the time section (see the right part of the graph) of the CMP gathers obtained by adding 30% of the color-changing noise to the signal trace gather (i.e. the target signal trace gather) shown in FIG. 13 according to the invention;

FIG. 20 is a graph illustrating the spectrum of the CMP gathers having color-changing noise added thereinto as shown in FIG. 19;

FIG. 21 is a flow chart depicting the implementation in a time domain of the simulating and noise-adding method according to the invention;

FIG. 22 is a flow chart depicting the implementation in a frequency-domain of the simulating and noise-adding method according to the invention;

FIG. 23 shows the simulating and noise-adding device according to a preferred embodiment of the invention.

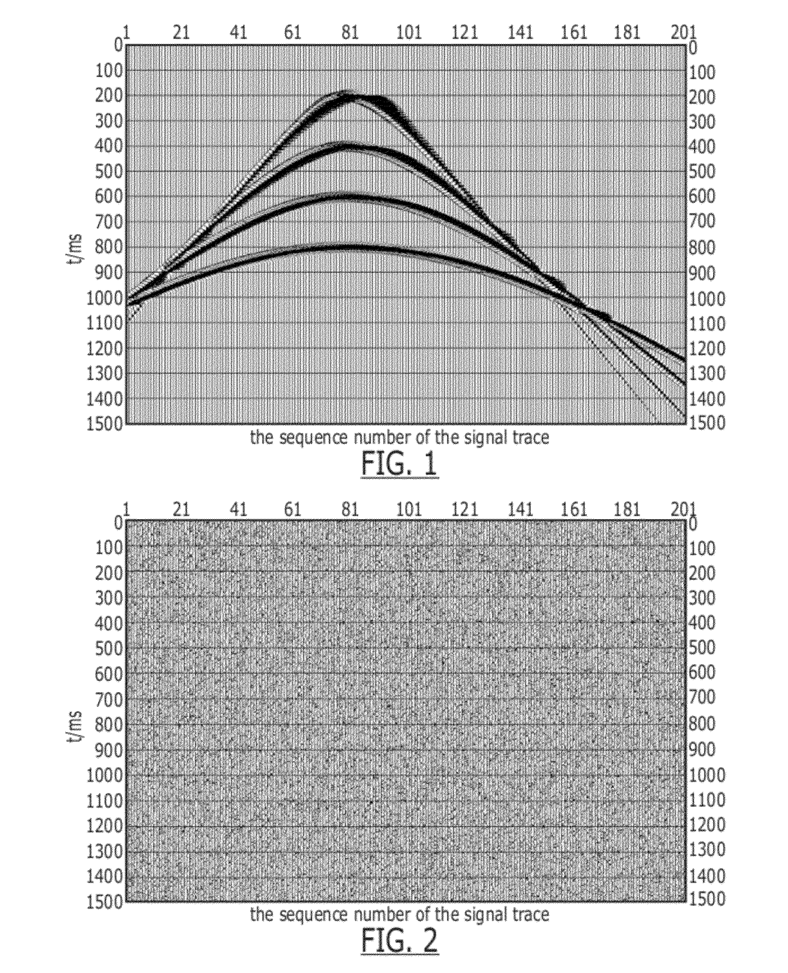

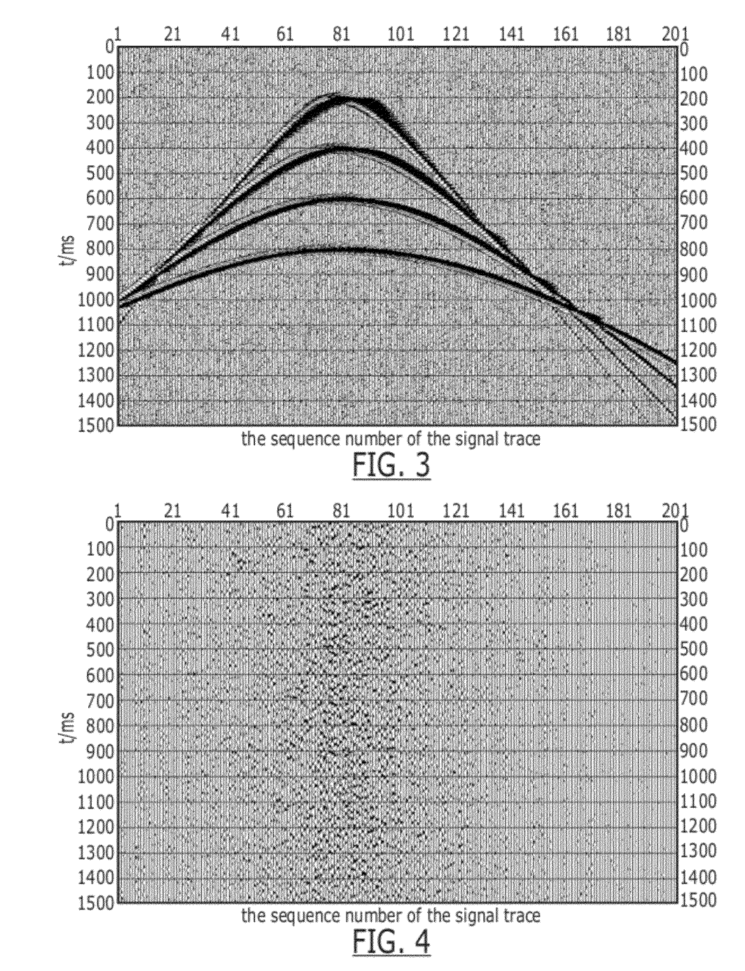

It is noted that, in all the figures depicting time sections, the horizontal axis represents the sequence number of the signal trace, and the vertical axis represents the time (t); in all the spectrums, the horizontal axis represents the frequency (f) and the vertical axis represents the amplitude (|A|); and in all the velocity spectrums, the horizontal axis represents the velocity (v) and the vertical axis represents the time (t).

### DETAILED DESCRIPTION OF THE INVENTION

Some terms are used to refer to specific system components throughout the application document. As will be understood by those skilled in the art, different names can be usually used to indicate the same component, so this application document does not intend to distinguish the components which are named differently but have the same function. In this application document, the terms “comprise”, “include”, “have” are used in an open mariner, so they should be construed as “comprise but not limited to . . . ”. In addition, the term “couple” or “couples” intends to mean indirect or direct electrical connection. Therefore, if a first device is coupled to a second device, the connection may be achieved through direct electrical connection or through indirect electrical connection via other devices and connections.

The invention will be described below with reference to the figures.

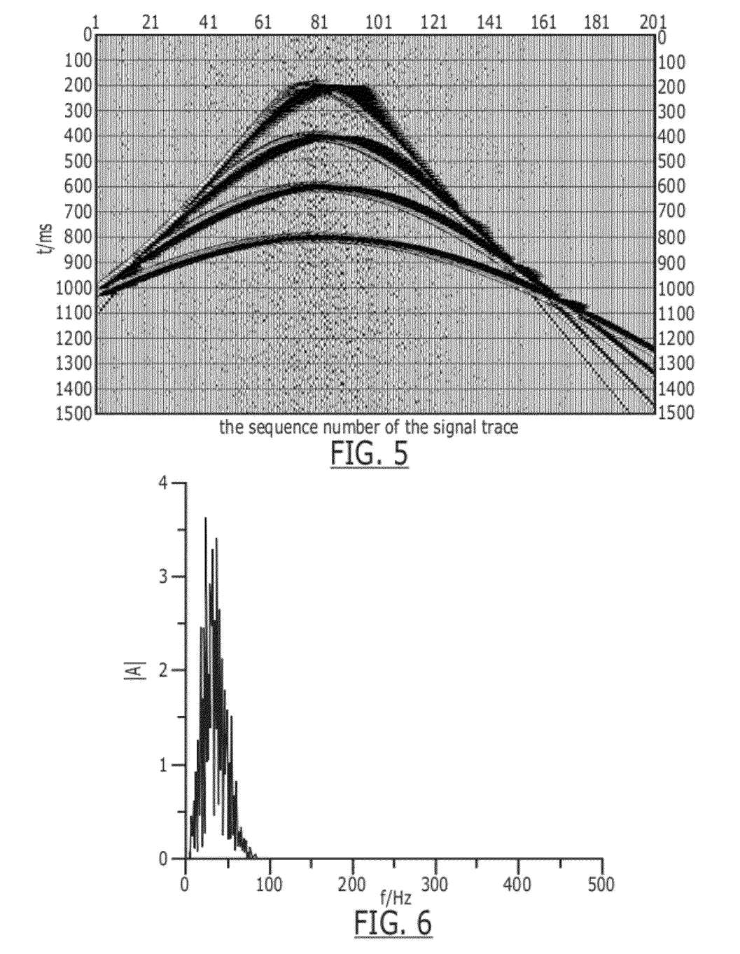

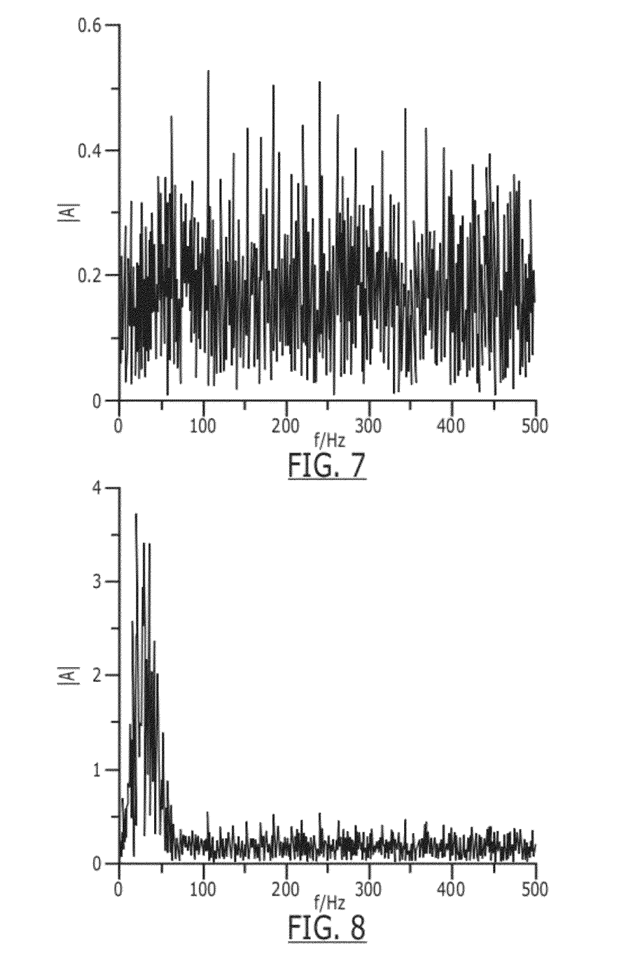

As described previously, the prior methods for adding noise to digital signals can be divided into two types, one is to add white noise to digital signals, and the other is to add colored noise to digital signals. However, both of these two types of noise-adding methods can not truly reflect or restore the original waveform system, so they have a low simulation degree, as shown in FIG. 3, FIG. 6, FIG. 7 and FIG. 8.

FIG. 6 shows the spectrum of the target signal trace gather S,(t) to be subject to the noise-adding processing, FIG. 7 shows the spectrum of the white noise signal trace gather Nᵢ(t), FIG. 3 shows the time section of the noise-added signal trace gather S′ᵢ(t) obtained by directly adding white noise signal traces to the target signal traces according to the prior art, and FIG. 8 shows the spectrum of the noise-added signal trace gather Sᵢ′(t) obtained by directly adding the white noise signal traces to the target signal traces.

As shown in FIG. 3, in the time section of the noise-added signal trace gather Sᵢ(t) obtained by directly adding white noise signal traces to the target signal traces, it can be seen an obvious sign of noise-adding processing. In addition, from the spectrum of the noise-added signal trace gather S′ᵢ(t) obtained by adding the white noise signal traces as shown in FIG. 8, it can also be seen that the added white noise are uniformly distributed throughout the whole frequency domain. Thus the conventional noise-adding processing of directly adding the white noise has a low simulation degree.

To overcome the deficiencies of the prior art, the invention provides a method for synthesizing a new noise (which is named color-changing noise herein) as well as a method and device for performing a noise-adding processing by using the new noise.

According to the first preferred embodiment, the invention provides a method for synthesizing the color-changing noise, which comprises the following steps:

Step 1: collecting target digital signals or target digital signal traces to be subject to the noise-adding processing;

Step 2: generating white noise signals or white noise signal traces;

Step 3: performing a convolution operation on the target digital signals and the white noise signals to generate color-changing noise signals, or performing a convolution operation on the target digital signal traces and the white noise signal traces to generate color-changing noise signal traces; and

Step 4: outputting the generated color-changing noise signals or color-changing noise signal traces.

Preferably, the method for synthesizing color-changing noise may be implemented in time domain, which comprises the following steps when it is implemented in time domain:

Collecting target digital signals S(t) or target digital signal traces Sᵢ(t) to be subject to the noise-adding processing, wherein t represents the time and i represents the sequence number of signal traces;

Generating white noise signals N(t) or white noise signal traces Nᵢ(t);

Performing a convolution operation on the target digital signals S(t) and the white noise signals N(t) to generate color-changing noise signals N̂(t), or performing a convolution operation on the target digital signal traces Sᵢ(t) and the white noise signal traces Nᵢ(t) to generate color-changing noise signal traces Nᵢ̂(t); and

Outputting the generated color-changing noise signals N̂(t) or color-changing noise signal traces Nᵢ̂(t).

Moreover, preferably, the method for synthesizing color-changing noise may also be implemented in a frequency domain, which comprises the following steps when it is implemented in frequency domain:

Collecting target digital signals S(t) or target digital signal traces Sᵢ(t) to be subject to the noise-adding processing;

Generating white noise signals N(t) or white noise signal traces Nᵢ(t);

Performing a Fourier transformation on the target digital signals S(t) or the target digital signal traces Sᵢ(t) to obtain target digital frequency-domain signals S(ω) or target digital frequency-domain signal traces Sᵢ(ω), wherein ω represents the frequency and i represents the sequence number of signal traces;

Performing Fourier transformation on the white noise signals N(t) or the white noise signal traces Nᵢ(t) to obtain white noise frequency-domain signals N(ω) or white noise frequency-domain signal traces Nᵢ(ω);

Performing multiplication operation on the target digital frequency-domain signals S(ω) and the white noise frequency-domain signals N(ω) to generate color-changing noise frequency-domain signals N̂(ω), or performing multiplication operation on the target digital frequency-domain signal traces Sᵢ(ω) and the white noise frequency-domain signal traces Nᵢ(ω) to generate color-changing noise frequency-domain signal traces Nᵢ̂(ω);

Performing an inverse Fourier transformation on the color-changing noise frequency-domain signals N̂(ω) or the color-changing noise frequency-domain signal traces Nᵢ̂(ω) to obtain the color-changing noise signals N̂(t) or the color-changing noise signal traces Nᵢ̂(t); and

Outputting the generated color-changing noise signals N̂(t) or color-changing noise signal traces Nᵢ̂(t).

Obviously, the Nᵢ̂(t) generated in the invention is not completely of the type of colored noise, when Sᵢ(t) is a white noise signal trace, Nᵢ̂(t) is also a white noise signal trace. Nᵢ̂(t) is a new type of random noise varied with the type of Sᵢ(t) between the white noise signal and the colored noise signal, so it is named color-changing noise in the invention.

As shown in FIG. 4 and FIG. 9, the color-changing noise Nᵢ̂(t) generated in the invention is still random noise, and the energy distribution characteristics (see FIG. 4) of Nᵢ̂(t) in the time section coincides with the energy distribution characteristics of the target digital signal traces Sᵢ(t), and the spectrum characteristics (see FIG. 9) of Nᵢ̂(t) also coincides with the spectrum characteristics of the Sᵢ(t).

Therefore, the result of analysis shows that the color-changing noise generated in the invention is a relatively natural and realistic synthetic random noise.

Now, the second preferred embodiment of the invention will be described as below.

According to the second embodiment, the invention provides a processing method for simulating and adding noise to digital signals, which comprises the following steps:

Step 1: collecting the target digital signals or target digital signal traces to be subject to the noise-adding processing;

Step 2: generating the white noise signals or white noise signal traces;

Step 3: performing a convolution operation on the target digital signals and the white noise signals to generate color-changing noise signals, or performing a convolution operation on the target digital signal traces and the white noise signal traces to generate color-changing noise signal traces;

Step 4: adding the generated color-changing noise signals to the target digital signals, or adding the generated color-changing noise signal traces to the target digital signal traces;

Step 5: outputting the digital signals or digital signal traces that have undergone the noise-adding processing.

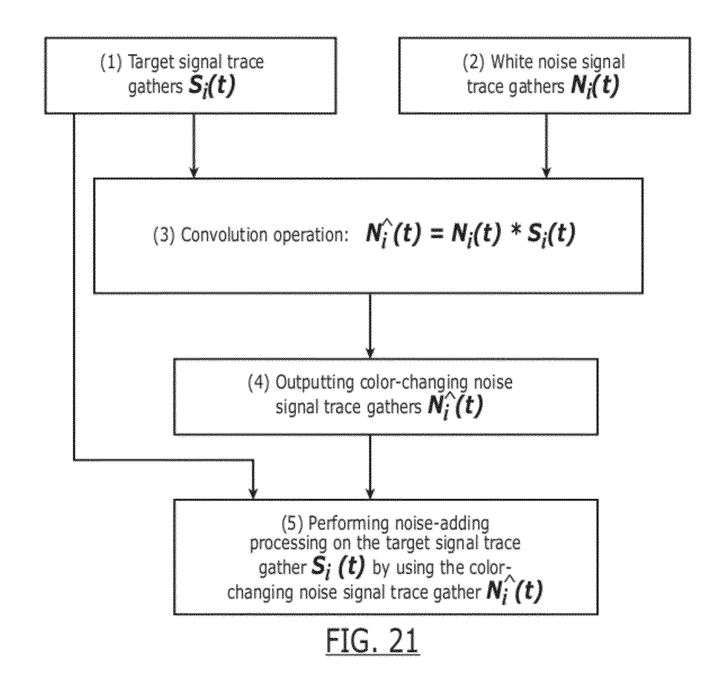

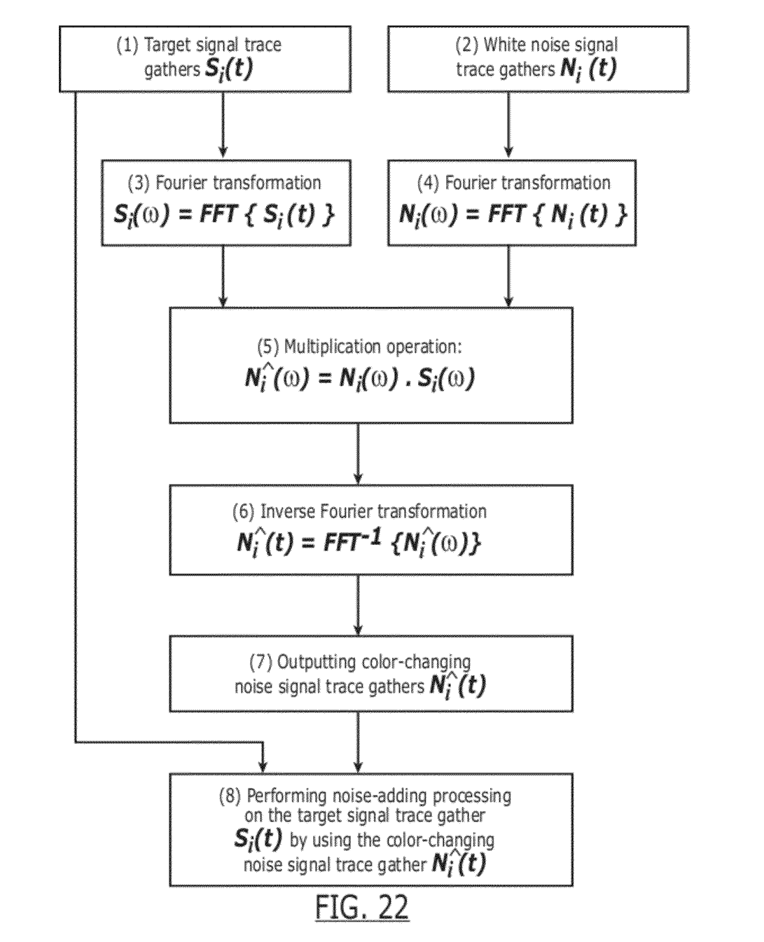

Preferably, as shown in FIG. 21, the processing method for simulating and adding noise to digital signals may be implemented in a time domain, and the method for simulating and adding noise comprises the following steps when it is implemented in a time domain:

(1) Collecting target digital signals S(t) or target digital signal traces Sᵢ(t) to be subject to the noise-adding processing, wherein t represents the time and i represents the sequence number of signal traces;

(2) Generating white noise signals N(t) or white noise signal traces Nᵢ(t);

(3) Performing a convolution operation on the target digital signals S(t) and the white noise signals N(t) (i.e. N̂(t)=N(t)*S(t)) to generate color-changing noise signals N̂(t), or performing a convolution operation on the target digital signal traces Sᵢ(t) and the white noise signal traces Nᵢ(t) (i.e. Nᵢ̂(t)=Nᵢ(t)* Sᵢ(t)) to generate color-changing noise signal traces Nᵢ̂(t); and

(4) Adding the generated color-changing noise signals N̂(t) to the target digital signals S(t), or adding the generated color-changing noise signal traces Nᵢ̂(t) to the target digital signal traces Sᵢ(t); and

(5) Outputting the noise-added digital signals Ŝ(t) or digital signal traces Sᵢ̂(t).

Preferably, the processing of adding color-changing noise signals as described in the above step (4) is performed according to the equation Ŝ(t)=S(t)+μN̂(t), wherein μ represents the proportionality coefficient, which can be determined by technicians according to the practical need.

Preferably, the processing of adding color-changing noise signal traces as described in the above step (4) is performed according to the equation Sᵢ̂(t)=Sᵢ(t)+μNᵢ̂(t), wherein i represents the sequence number of the signal traces, which is a positive integer; μ represents the proportionality coefficient, which is preferably a percentage between 0 and 1.

Preferably, as shown in FIG. 22, the processing method for simulating and adding noise to digital signals may be implemented in frequency domain, and the method for simulating and adding noise comprises the following steps when it is implemented in frequency domain:

(1) Collecting target digital signals S(t) or target digital signal traces Sᵢ(t) to be subject to the noise-adding processing;

(2) Generating white noise signals N(t) or white noise signal traces Nᵢ(t);

(3) Performing Fourier transformation on the target digital signals S(t) or the target digital signal traces Sᵢ(t) to obtain target digital frequency-domain signals S(ω) (i.e. S(ω)=FFT{S(t)}) or target digital frequency-domain signal traces Sᵢ(ω) (i.e. Sᵢ(ω)=FFT{Sᵢ(t)});

(4) Performing Fourier transformation on the white noise signals N(t) or the white noise signal traces Nᵢ(t) to obtain white noise frequency-domain signals N(ω) (i.e. N(ω)=FFT{N(t)}) or white noise frequency-domain signal traces Nᵢ(ω) (i.e. Nᵢ(ω) FFT{Nᵢ(t)});

(5) Performing multiplication operation on the target digital frequency-domain signals S(ω) and the white noise frequency-domain signals N(ω) to generate color-changing noise frequency-domain signals N̂(ω) (i.e. N̂(ω)=N(ω)·S(ω))), or performing multiplication operation on the target digital frequency-domain signal traces Sᵢ(ω) and the white noise frequency-domain signal traces Nᵢ(ω) to generate color-changing noise frequency-domain signal traces Nᵢ̂(ω) (i.e. Nᵢ̂(ω)=Nᵢ(ω)·Sᵢ(ω));

(6) Performing inverse Fourier transformation on the color-changing noise frequency-domain signals N̂(ω) or the color-changing noise frequency-domain signal traces Nᵢ̂(ω) to obtain the color-changing noise signals N̂(t) (i.e. N̂(t)=FFT⁻¹{N̂(ω)}) or the color-changing noise signal traces Nᵢ̂(t) (i.e. Nᵢ̂(t)=FFT⁻¹{Nᵢ̂(ω)});

(7) Outputting the generated color-changing noise signals N̂(t) or color-changing noise signal traces Nᵢ̂(t)

(8) Adding the generated color-changing noise signals N̂(t) to the target digital signals S(t), or adding the generated color-changing noise signal traces Nᵢ̂(t) to the target digital signal traces Sᵢ(t); and

(9) Outputting the noise-added digital signals Ŝ(t) or digital signal traces Sᵢ̂(t) (this step is not shown in FIG. 22).

Preferably, the processing of adding color-changing noise signals as described in the above step (8) is performed according to the equation Ŝ(t)=S(t)+μN̂(t), wherein μ represents the proportionality coefficient, which can be determined by technicians according to the practical need.

Preferably, the processing of adding color-changing noise signal traces as described in the above step (8) is performed according to the equation Sᵢ̂(t)=Sᵢ(t)+μNᵢ̂(t), wherein i represents the sequence number of the signal traces, and μ represents the proportionality coefficient.

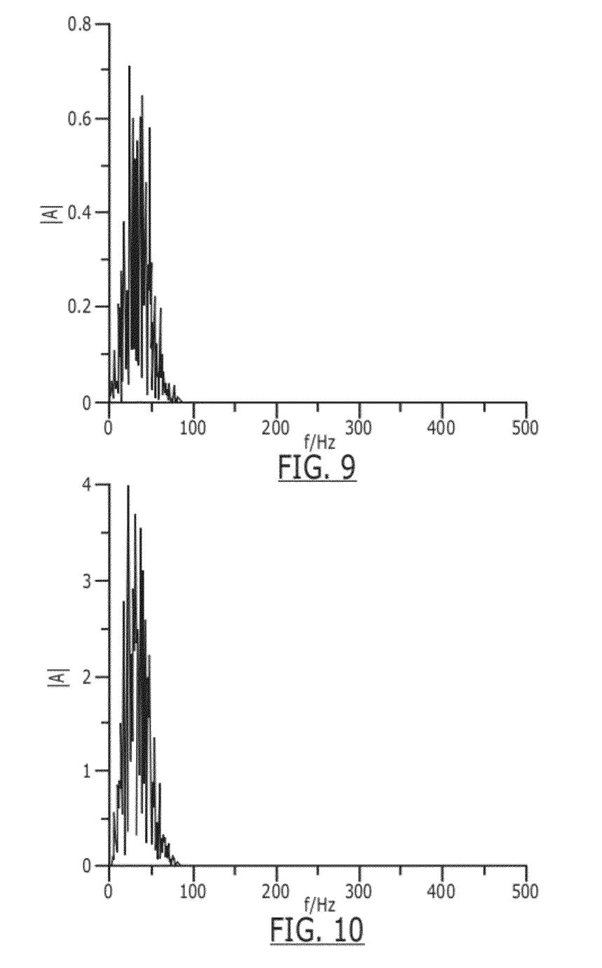

By comparing FIG. 5 (i.e. the time section of the noise-added signal trace gather according to the invention) with FIG. 3 (i.e. the time section of the noise-added signal trace gather according to the prior art) and comparing FIG. 10 (i.e. the spectrum of the noise-added signal trace gather according to the invention) with FIG. 8 (i.e. the spectrum of the noise-added signal trace gather according to the prior art), it can be seen clearly that in either the time section (FIG. 5) or the spectrum (FIG. 10) of the digital signal traces Sᵢ̂(t) obtained by performing a noise-adding processing using the color-changing noise generated according to the invention, there is almost no sign of the noise-adding processing. This can prove that the color-changing noise generated according to the invention is a natural and realistic synthetic random noise, and the target signals or signal traces that have undergone the noise-adding with the color-changing noise has extremely high simulation degree compared to the prior art noise-adding methods.

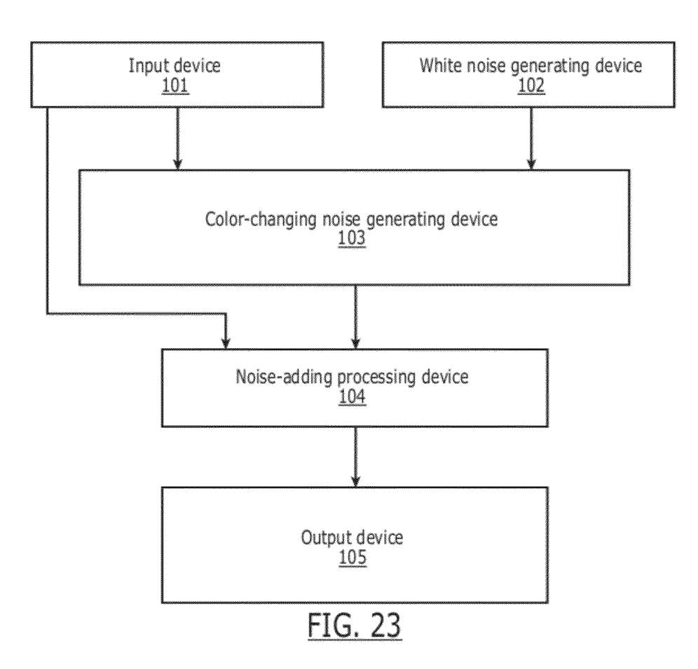

Next, the third embodiment of the invention will be described in detail with reference to FIG. 23.

FIG. 23 shows the third embodiment of the present invention, which relates to a simulating and noise-adding device 100 for simulating and adding noise to digital signals, the device comprises:

An input means 101 for inputting the target digital signals or target digital signal traces to be subject to the noise-adding processing;

A white noise generating means 102 for generating white noise signals or white noise signal traces;

A color-changing noise generating means 103, which is coupled to the input means 101 and the white noise generating means 102, and is configured to perform a convolution operation on the target digital signals and the white noise signals to generate color-changing noise signals, or to perform a convolution operation on the target digital signal traces and the white noise signal traces to generate color-changing noise signal traces;

A noise-adding processing means 104, which is coupled to the input means 101 and the color-changing noise generating means 103, and is configured to add the generated color-changing noise signals to the target digital signals, or to add the generated color-changing noise signal traces to the target digital signal traces;

An output means 105 for outputting the noise-added digital signals or digital signal traces.

Preferably, the color-changing noise generating means 103 is further configured to perform a convolution operation on the target digital signals S(t) and the white noise signals N(t) (i.e. N̂(t)=N(t)*S(t)) to generate the color-changing noise signals N̂(t), or to perform a convolution operation on the target digital signal traces Sᵢ(t) and the white noise signal traces Nᵢ(t) (i.e. Nᵢ̂(t)=Nᵢ(t)*Sᵢ(t)) to generate the color-changing noise signal traces Nᵢ̂(t).

Alternatively, the color-changing noise generating means 103 is further configured to:

Performing Fourier transformation on the target digital signals S(t) or the target digital signal traces Sᵢ(t) to obtain target digital frequency-domain signals S(ω) (i.e. S(ω)=FFT{S(t)}) or target digital frequency-domain signal traces Sᵢ(ω) (i.e. Sᵢ(ω)=FFT{Sᵢ(t)});

Performing Fourier transformation on the white noise signals N(t) or the white noise signal traces Nᵢ(t) to obtain white noise frequency-domain signals N(ω) (i.e. N(ω)=FFT{N(t)}) or white noise frequency-domain signal traces Nᵢ(ω) (i.e. Nᵢ(ω)=FFT{Nᵢ(t)});

Performing multiplication operation on the target digital frequency-domain signals S(ω) and the white noise frequency-domain signals N(ω) to generate color-changing noise frequency-domain signals N̂(ω) (i.e. N̂(ω)=N(ω)·S(ω)), or perform multiplication operation on the target digital frequency-domain signal traces Sᵢ(ω) and the white noise frequency-domain signal traces Nᵢ(ω) to generate color-changing noise frequency-domain signal traces N̂(ω) (i.e. Nᵢ̂(ω)=Nᵢ(ω)·Sᵢ(ω));

Performing inverse Fourier transformation on the color-changing noise frequency-domain signals N̂(ω) or the color-changing noise frequency-domain signal traces Nᵢ̂(ω) to obtain the color-changing noise signals N̂(t) (i.e. N̂(t)=FFT⁻¹{N̂(ω)}) or the color-changing noise signal traces Nᵢ̂(t) (i.e. Nᵢ̂(t)=FFT⁻¹{Nᵢ̂(ω)}).

Preferably, the noise-adding processing means 104 is further configured to perform the noise-adding according to the equation Ŝ(t)=S(t)+μN̂(t), wherein S(t) represents the target digital signal to be subject to the noise-adding processing, N̂(t) represents the color-changing noise signal, μ represents the proportionality coefficient, and Ŝ(t) represents the noise-added digital signal.

Preferably, the noise-adding processing means 104 is further configured to perform the noise-adding according to the equation Sᵢ̂(t)=Sᵢ(t)+μNᵢ̂(t), wherein Sᵢ(t) represents the target digital signal trace, Nᵢ̂(t) represents the color-changing noise signal trace, Sᵢ̂(t) represents the noise-added digital signal trace, i represents the sequence number of the signal trace, μ represents the proportionality coefficient, and t represents the time.

The characteristics and advantages of the present invention will be further described with reference to the following specific examples.

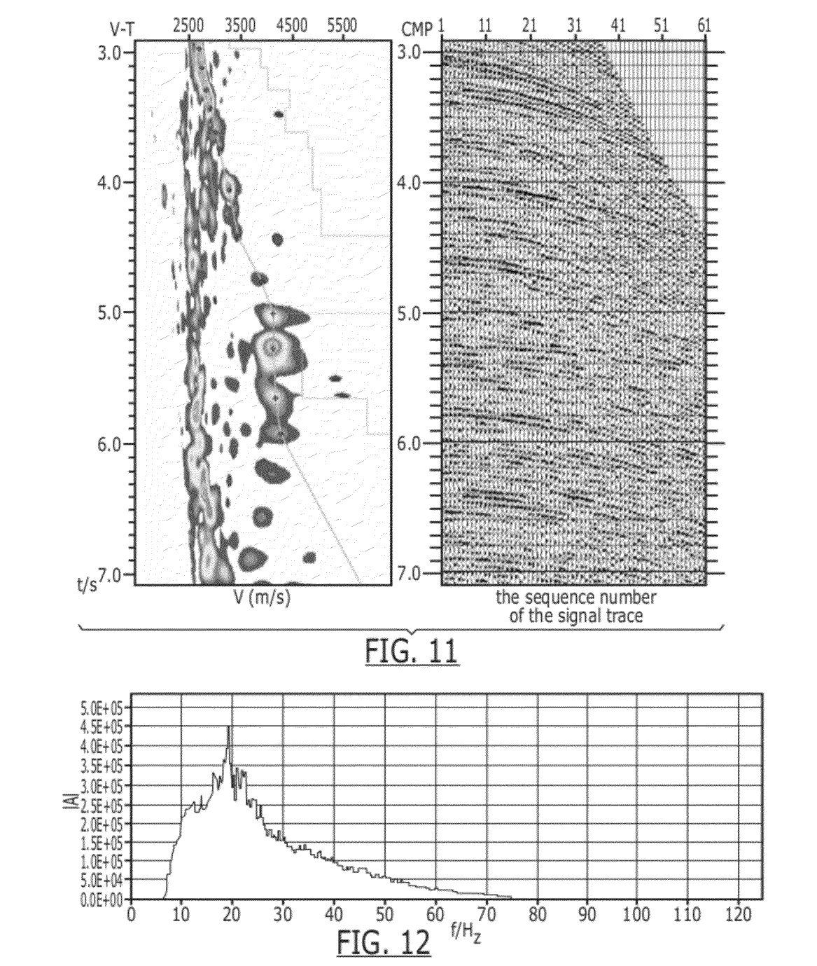

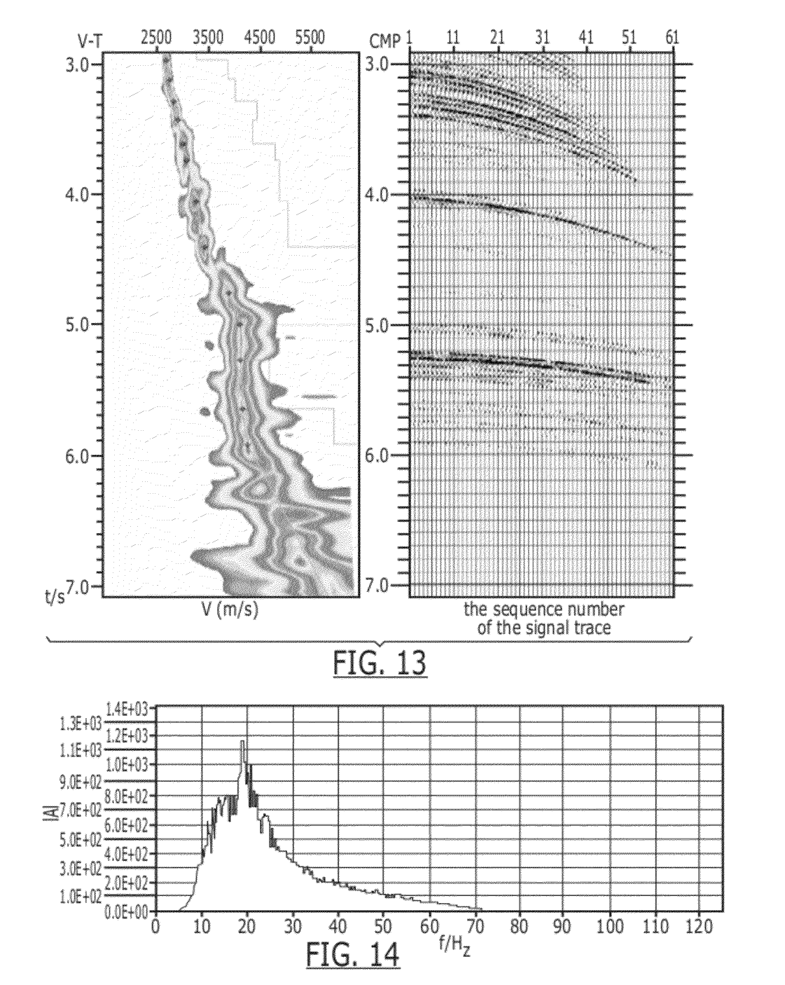

FIG. 11 shows the velocity spectrum (see the left part of the graph) and the time section (see the right part of the graph) of a group of original CMP gathers (i.e. Common Midpoint gathers) collected at a seismic prospecting working area according to a preferred embodiment of the invention. FIG. 12 shows the spectrum of the original CMP gathers as shown in FIG. 11. It can be seen from these two figures that serious multi-wave interference occurs under 3500 ms.

FIG. 13 shows the velocity spectrum (see the left part of the graph) and the time section (see the right part of the graph) of the CMP gathers obtained by eliminating the multi-wave interference to the original CMP gathers as shown in FIG. 11 and FIG. 12. FIG. 14 shows the spectrum of the CMP gathers obtained by denoising the CMP gathers having the multi-wave interference eliminated as shown in FIG. 13. It can be seen from the velocity spectrum depicted in FIG. 13 that the multi-wave interference has been eliminated, but there is still one problem that the CMP gathers looks like a synthetic model and is unnatural.

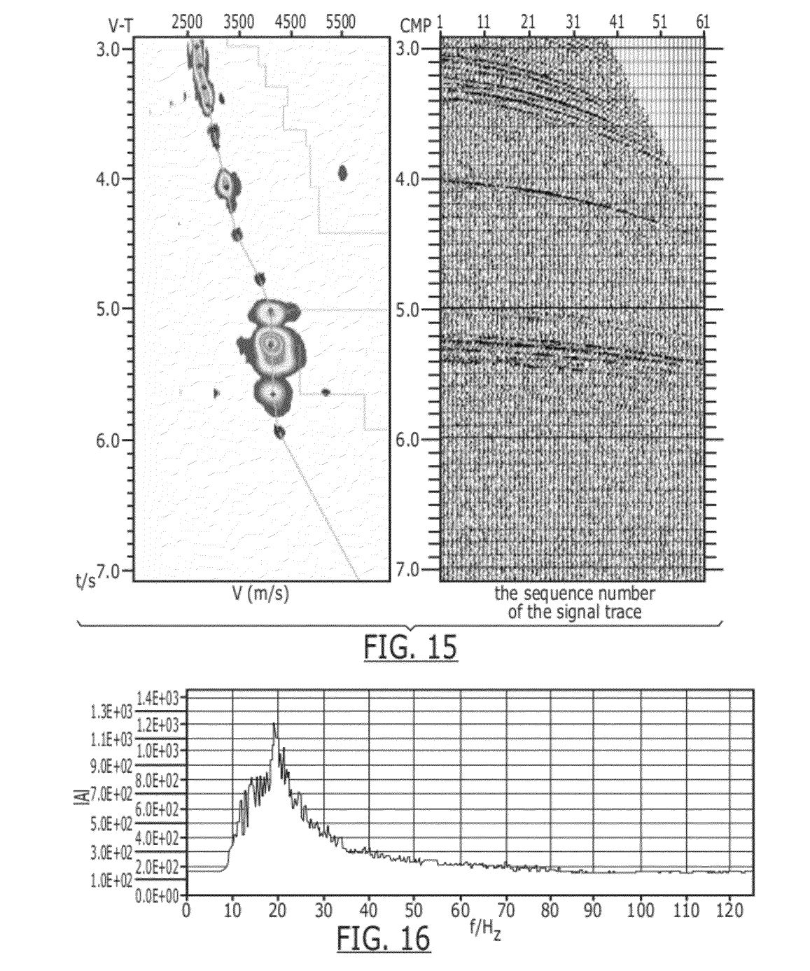

FIG. 15 shows the velocity spectrum (see the left part of the graph) and the time section (see the right part of the graph) of the CMP gathers obtained by adding white noise to the signal trace gathers as shown in FIG. 13. FIG. 16 shows the spectrum of the CMP gathers obtained by adding white noise to the signal trace gathers as shown in FIG. 13. FIG. 17 shows the spectrum of the band-pass filtered CMP gathers obtained by band-pass filtering the CMP gathers having white noise added thereto as shown in FIG. 15 and FIG. 16. It can be seen from these three figures that there is an obvious sign of adding the white noise in either the time section (FIG. 15) or the spectrum (FIG. 16). Although the band-pass filtering (5, 10, 60, 80 Hz) can hide the noise-adding signs in the time section, the output spectrum (FIG. 17) still shows signs of adding white noise, and this is not desirable in the data analysis process.

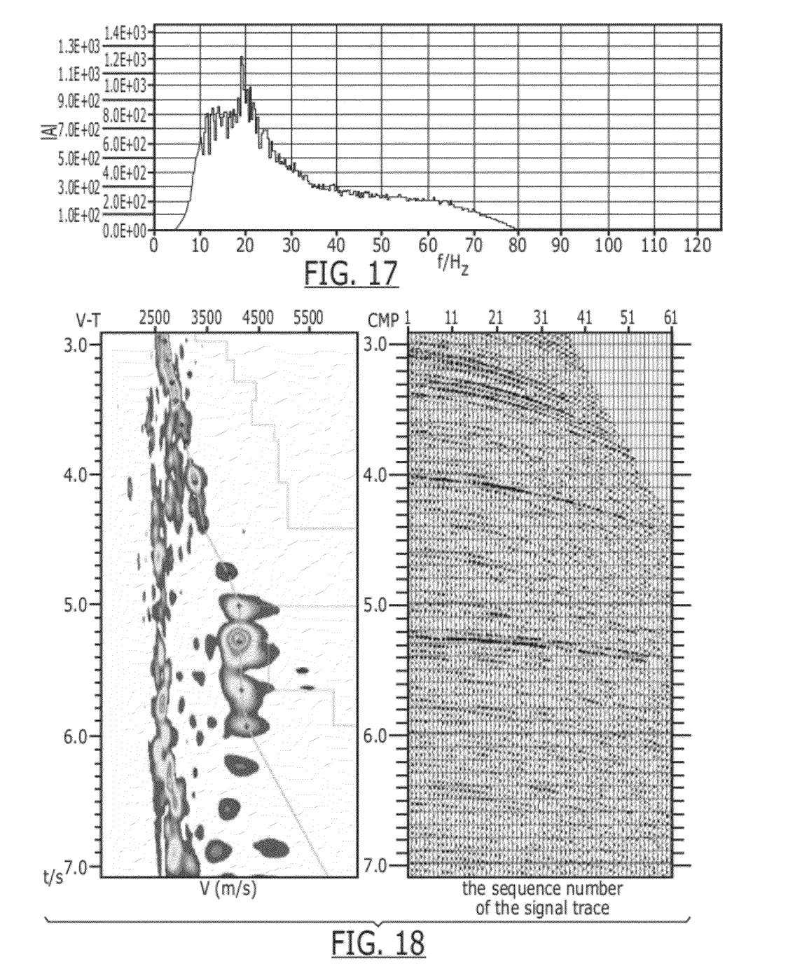

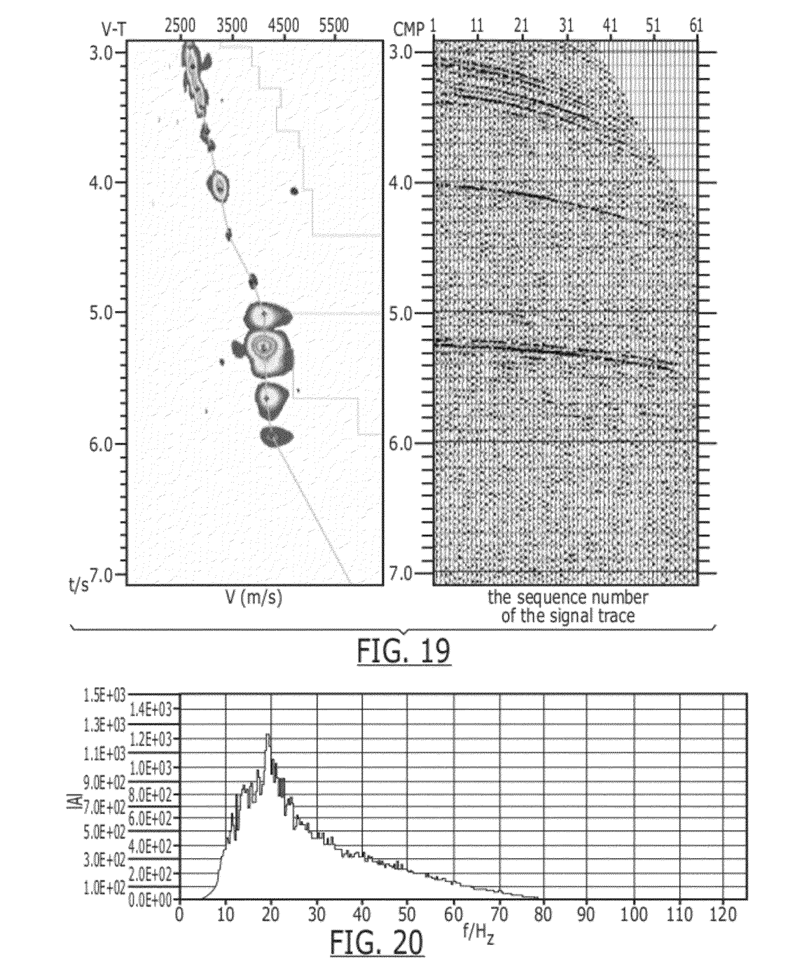

FIG. 18 shows the velocity spectrum (see the left part of the graph) and the time section (see the right part of the graph) of the CMP gathers obtained by adding 30% of the original noise (i.e. colored noise) to the sign trace gathers shown in FIG. 13 according to the prior art. It can be seen from FIG. 18 that the multi-wave interference in the CMP gathers is weakened to some extent, but in the velocity spectrum, there is still large multi-wave energy, which is very disadvantageous.

FIG. 19 shows the velocity spectrum (see the left part of the graph) and the time section (see the right part of the graph) of the CMP gathers obtained by adding 30% of the color-changing noise to the signal trace gathers (i.e. the target signal trace gathers) shown in FIG. 13 according to the invention. FIG. 20 shows the spectrum of the CMP gathers having color-changing noise added thereinto as shown in FIG. 19. It can be seen from these two figures that the time section of the CMP gathers looks natural, and there is no multi-wave in the velocity spectrum. Further, by comparing the spectrums of the CMP gathers shown in FIG. 19 with the spectrums of the target signal trace gathers, it can be seen that adding the color-changing noise to the target signal trace gathers does not change the spectrum characteristics of the target signal trace gathers. Therefore, there is almost no sign of noise-adding processing either in the time section or in the spectrum, and the result is ideal.

It can be seen from the above illustration that the outputted signal trace gathers obtained by performing noise-adding processing with the color-changing noise generated according to the invention is characterized in that an obvious noise is shown in time domain, but there is no obvious noise shown in the frequency domain. In other words, signs of noise-adding processing can not be seen either in the time section or in the spectrum of the noise-added signal traces according to the invention, and the noise-added signal traces have extremely high degree of simulation, so this is very helpful in solving problems of noise suppression, simulating and noise-adding in digital signal processing.

The above explanation of the embodiment is nothing more than illustrative in any respect, nor should be thought of as restrictive. Scope of the present invention is indicated by claims rather than the above embodiment. Further, it is intended that all changes that are equivalent to a claim in the sense and realm of the doctrine of equivalence be included within the scope of the present invention.

What is claimed is:

1. A processing method for simulating and adding noise to digital signals, characterized in that this method comprises the following steps:
step 1: collecting the target digital signals or target digital signal traces to be subject to the noise-adding processing;
step 2: generating the white noise signals or white noise signal traces;
step 3: performing a convolution operation on the target digital signals and the white noise signals to generate color-changing noise signals, or performing a convolution operation on the target digital signal traces and the white noise signal traces to generate color-changing noise signal traces; and
step 4: adding the generated color-changing noise signals to the target digital signals, or adding the generated color-changing noise signal traces to the target digital signal traces.

2. The method according to claim 1, characterized in that step 3 further comprises:
performing a convolution operation on the target digital signals S(t) and the white noise signals N(t) to generate color-changing noise signals N̂(t), or performing a convolution operation on the target digital signal traces Sᵢ(t) and the white noise signal traces Nᵢ(t) to generate color-changing noise signal traces Nᵢ̂(t), wherein t represents the time and i represents the sequence number of signal traces.

3. The method according to claim 1, characterized in that step 3 further comprises:
performing a Fourier transformation on the target digital signals S(t) or the target digital signal traces Sᵢ(t) to obtain target digital frequency-domain signals S(ω) or target digital frequency-domain signal traces Sᵢ(ω);
performing a Fourier transformation on the white noise signals N(t) or the white noise signal traces Nᵢ(t) to obtain white noise frequency-domain signals N(ω) or white noise frequency-domain signal traces Nᵢ(ω);
wherein t represents the time, i represents the sequence number of signal traces and ω represents the frequency.

4. The method according to claim 3, characterized in that step 3 further comprises:
performing multiplication operation on the target digital frequency-domain signals S(ω) and the white noise frequency-domain signals N(ω) to generate color-changing noise frequency-domain signals N̂(ω), or performing multiplication operation on the target digital frequency-domain signal traces Sᵢ(ω) and the white noise frequency-domain signal traces Nᵢ(ω) to generate color-changing noise frequency-domain signal traces Nᵢ̂(ω); and
performing an inverse Fourier transformation on the color-changing noise frequency-domain signals N̂(ω) or the color-changing noise frequency-domain signal traces Nᵢ̂(ω) to obtain the color-changing noise signals N̂(t) or the color-changing noise signal traces Nᵢ̂(t);
wherein t represents the time, i represents the sequence number of signal traces, and ω represents the frequency.

5. The method according to claim 2, characterized in that the processing of adding color-changing noise signals as described in step 4 is performed according to the following equation:
Ŝ(t)=S(t)+μN̂(t), wherein μ represents the proportionality coefficient and t represents the time.

6. The method according to claim 2, characterized in that the processing of adding color-changing noise signals as described in step 4 is performed according to the following equation:
Sᵢ̂(t)=Sᵢ(t)+μNᵢ̂(t), wherein i represents the sequence number of signal trace, μ represents the proportionality coefficient and t represents the time.

7. The method according to claim 1, characterized in that the target digital signal traces are the signal traces of the multi-dimensionally filtered seismic data.

8. A method of generating color-changing noise, characterized in that the method comprises the steps of:
step 1: collecting target digital signals or target digital signal traces;
step 2: generating white noise signals or white noise signal traces; and
step 3: performing a convolution operation on the target digital signals and the white noise signals to generate color-changing noise signals, or performing a convolution operation on the target digital signal traces and the white noise signal traces to generate color-changing noise signal traces.

9. The method according to claim 8, characterized in that step 3 further comprises:
performing a convolution operation on the target digital signals S(t) and the white noise signals N(t) to generate color-changing noise signals N̂(t), or performing a convolution operation on the target digital signal traces Sᵢ(t) and the white noise signal traces Nᵢ(t) to generate color-changing noise signal traces Nᵢ̂(t), wherein t represents the time and i represents the sequence number of signal traces.

10. The method according to claim 8, characterized in that step 3 further comprises:
performing a Fourier transformation on the target digital signals S(t) or the target digital signal traces Sᵢ(t) to obtain target digital frequency-domain signals S(ω) or target digital frequency-domain signal traces Sᵢ(ω);
performing a Fourier transformation on the white noise signals N(t) or the white noise signal traces Nᵢ(t) to obtain white noise frequency-domain signals N(ω) or white noise frequency-domain signal traces Nᵢ(ω);
wherein t represents the time, i represents the sequence number of signal traces and ω represents the frequency.

11. The method according to claim 10, characterized in that step 3 further comprises:
performing multiplication operation on the target digital frequency-domain signals S(ω) and the white noise frequency-domain signals N(ω) to generate color-changing noise frequency-domain signals N̂(ω), or performing multiplication operation on the target digital frequency-domain signal traces Sᵢ(ω) and the white noise frequency-domain signal traces Nᵢ(ω) to generate color-changing noise frequency-domain signal traces Nᵢ̂(ω);
performing an inverse Fourier transformation on the color-changing noise frequency-domain signals N̂(ω) or the color-changing noise frequency-domain signal traces Nᵢ̂(ω) to obtain the color-changing noise signals N̂(t) or the color-changing noise signal traces Nᵢ̂(t);
wherein t represents the time, i represents the sequence number of signal traces, and ω represents the frequency.

12. A device for simulating and adding noise to digital signals, characterized in that the device comprises:
an input means (101) for inputting the target digital signals or target digital signal traces to be subject to the noise-adding processing;
a white noise generating means (102) for generating white noise signals or white noise signal traces;
a color-changing noise generating means (103), which is coupled to the input means (101) and the white noise generating means (102), and is configured to perform a convolution operation on the target digital signals and the white noise signals to generate color-changing noise signals or to perform a convolution operation on the target digital signal traces and the white noise signal traces to generate color-changing noise signal traces; and
a noise-adding processing means (104), which is coupled to the input means (101) and the color-changing noise generating means (103), and is configured to add the generated color-changing noise signals to the target digital signals, or to add the generated color-changing noise signal traces to the target digital signal traces.

13. The device according to claim 12, characterized in that the color-changing noise generating means (103) is further configured to perform a convolution operation on the target digital signals S(t) and the white noise signals N(t) to generate the color-changing noise signals N̂(t), or to perform a convolution operation on the target digital signal traces Sᵢ(t) and the white noise signal traces Nᵢ(t) to generate the color-changing noise signal traces Nᵢ̂(t), wherein t represents the time and i represents the sequence number of signal traces.

14. The device according to claim 12, characterized in that the color-changing noise generating means (103) is further configured to:
perform a Fourier transformation on the target digital signals S(t) or the target digital signal traces Sᵢ(t) to obtain target digital frequency-domain signals S(ω) or target digital frequency-domain signal traces Sᵢ(ω); and
perform a Fourier transformation on the white noise signals N(t) or the white noise signal traces Nᵢ(t) to obtain white noise frequency-domain signals N(ω) or white noise frequency-domain signal traces Nᵢ(ω);
wherein t represents the time, i represents the sequence number of signal traces, and ω represents the frequency.

15. The device according to claim 14, characterized in that the color-changing noise generating means (103) is further configured to:
perform multiplication operation on the target digital frequency-domain signals S(ω) and the white noise frequency-domain signals N(ω) to generate color-changing noise frequency-domain signals N̂(w), or perform multiplication operation on the target digital frequency-domain signal traces Sᵢ(ω) and the white noise frequency-domain signal traces Nᵢ(ω) to generate color-changing noise frequency-domain signal traces Nᵢ̂(ω); and
perform an inverse Fourier transformation on the color-changing noise frequency-domain signals N̂(ω) or the color-changing noise frequency-domain signal traces Nᵢ̂(ω) to obtain the color-changing noise signals N̂(t) or the color-changing noise signal traces Nᵢ̂(t),
wherein t represents the time, i represents the sequence number of signal traces, and ω represents the frequency.

16. The device according to claim 13, characterized in that the noise-adding processing means (104) is further configured to perform the noise-adding processing according to the following equation:
Ŝ(t)=S(t)+μN̂(t), wherein S(t) is the target digital signal to be subject to the noise-adding processing, N̂(t) is the color-changing noise signal, Ŝ(t) is the noise-added digital signal, μ represents the proportionality coefficient, and t represents the time.

17. The device according to claim 13, characterized in that the noise-adding processing means (104) is further configured to perform the noise-adding processing according to the following equation:
Sᵢ̂(t)=Sᵢ(t)+μNᵢ̂(t), wherein Sᵢ(t) is the target digital signal trace, Nᵢ̂(t) is the color-changing noise signal trace, Sᵢ̂(t) is the noise-added digital signal trace, i represents the sequence number of the signal trace, μ represents the proportionality coefficient, and t represents the time.

18. The device according to claim 12, characterized in that the target digital signal traces are the signal traces of the multi-dimensionally filtered seismic data.

19. The device according to claim 12, characterized in that the device is used for simulating and adding noise to the multi-dimensionally filtered digital seismic signals during processing of the seismic wave.
